(19) United States
(12) Patent Application Publication
(10) Pub. No.: US 2025/0137852 A1
(43) Pub. Date: May 1, 2025

(54) Temperature Sensor for a Battery Module

(71) Applicant: Ticona LLC, Florence, KY (US)

(72) Inventors: Shuai Xu, Shanghai (CN); Fangfang Tao, Shanghai (CN)

(21) Appl. No.: 18/686,899

(22) PCT Filed: Jul. 22, 2022
(86) PCT No.: PCT/CN2022/107312

§ 371 Date: Feb. 27, 2024

(51) Int. Cl. G01K 1/12; C09K 19/38; C09K 19/52; G01K 1/14; G01K 7/22; H01M 10/48

(52) U.S. Cl. CPC G01K 1/12; C09K 19/3809; C09K 19/52; G01K 1/14; H01M 10/486; C09K 2019/521; G01K 7/22; H01M 2220/20

(57) ABSTRACT

A temperature sensor comprising a housing that receives a temperature measuring element is provided. The housing includes a polymer composition comprising a polymer matrix that includes a thermotropic liquid crystalline polymer. The polymer composition exhibits a melt viscosity of about 150 Pa−s or less and a deflection temperature under load of about 170° C. or more.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. As electric vehicle technology continues to evolve, there is a need to provide improved battery systems for such vehicles to increase the distance that such vehicles may travel without the need to recharge. In this regard, lithium-ion batteries are often employed that have a high charge density and can thus store a high level of charge. Unfortunately, lithium-ion batteries also tend to be sensitive to temperature and can thus experience failure when excessively high temperatures are reached. For this reason, temperature sensors are typically employed in the lithium-ion battery modules to help determine when the batteries are at risk during operation. While somewhat effective, the temperature sensors themselves can be susceptible to high temperatures, causing them to fail or exhibit a slow response time. As such, a need currently exists for an improved temperature sensor for use in a battery module.

### SUMMARY OF THE INVENTION

In accordance with one embodiment of the present invention, a temperature sensor is disclosed that comprises a housing that receives a temperature measuring element. The housing includes a polymer composition comprising a polymer matrix that includes a thermotropic liquid crystalline polymer. The polymer composition exhibits a melt viscosity of about 300 Pa−s or less and a deflection temperature under load of about 170° C. or more.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of one embodiment of the main portion of a battery module that may employ the temperature sensor of the present invention;

FIG. 2 is an exploded view of the temperature sensor shown in FIG. 1;

FIG. 3 is an exploded view of a sensor body and connector body of the temperature sensor of FIG. 2; and

FIG. 4 illustrates one embodiment of an electric vehicle that may employ the temperature sensor of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a temperature sensor for use in a battery module, such as employed in electric vehicles. The temperature sensor includes a housing that receives a temperature measuring element (e.g., thermistor, thermocouples, etc.). Notably, the housing contains a polymer composition that includes a liquid crystalline polymer and exhibits the combination of high flow properties and good heat resistance. More particularly, the composition may exhibit a melt viscosity of about 300 Pa−s or less, in some embodiments about 150 Pa−s or less, in some embodiments from about 5 to about 100 Pa−s, in some embodiments from about 10 to about 95 Pa−s, and in some embodiments, from about 15 to about 80 Pa−s, as determined in accordance with ISO 11443:2021 at a shear rate of 1,000 s⁻¹ and temperature of about 15° C. above the melting temperature of the composition (e.g., about 350° C.). The deflection temperature under load (“DTUL”), a measure of short term heat resistance may also remain relatively high. For instance, the DTUL may be about 170° C. or more, in some embodiments about 200° C. or more, in some embodiments from about 210° C. to about 300° C., and in some embodiments, from about 220° C. to about 280° C., such as determined in accordance with ISO 75:2013 at a load of 1.8 MPa. Even at such DTUL values, the ratio of the melting temperature to the DTUL value may still remain relatively high. For example, the ratio may range from about 0.5 to about 1.00, in some embodiments from about 0.6 to about 0.95, and in some embodiments, from about 0.65 to about 0.85. The specific melting temperature of the polymer composition may, for instance, be from about 250° C. to about 440° C., in some embodiments from about 260° C. to about 400° C., and in some embodiments, from about 300° C. to about 380° C.

In addition to exhibiting good flow properties and heat resistance, the polymer composition may exhibit a high degree of thermal conductivity. Such high thermal conductivity values allow the composition to be capable of creating a thermal pathway for heat transfer away from the sensor. In this manner, “hot spots” can be quickly eliminated and the overall temperature can be lowered during use. The polymer composition may, for example, exhibit an in-plane (or “flow”) thermal conductivity of about 2 W/m−K or more, in some embodiments from about 2.5 to about 15 W/m−K, in some embodiments about 3 to about 10 W/m−K, and in some embodiments, from about 4 to about 8 W/m−K, as determined in accordance with ASTM E 1461-13 (2022). Similarly, the polymer composition may exhibit a cross-plane (or “cross-flow”) thermal conductivity of about 0.8 W/m−K or more, in some embodiments from about 1 to about 12 W/m−K, and in some embodiments, from about 2 to about 8 W/m−K, as determined in accordance with ASTM E 1461-13 (2022). The composition may also exhibit a through-plane thermal conductivity of about 0.2 W/m-K or more, in some embodiments about 0.3 W/m−K or more, in some embodiments about 0.5 to about 4 W/m−K, and in some embodiments, from about 0.6 to about 2 W/m−K, as determined in accordance with ASTM E 1461-13 (2022).

While being thermally conductive, the polymer composition may nevertheless may be electrically insulative and maintain a high degree of short-term dielectric strength even when exposed to an electric field. The “dielectric strength” generally refers to the voltage that the material can withstand before breakdown occurs. For instance, the polymer composition may generally exhibit a dielectric strength of about 10 kilovolts per millimeter (kV/mm) or more, in some embodiments about 15 kV/mm or more, and in some embodiments, from about 25 kV/mm to about 60 kV/mm, such as determined in accordance with IEC 60234-1:2013. The insulative properties of the polymer composition may also be characterized by a high comparative tracking index (“CTI”), such as about 150 volts or more, in some embodiments about 170 volts or more, in some embodiments about 200 volts or more, and in some embodiments, from about 220 to about 350 volts, such as determined in accordance with IEC 60112:2003 at a thickness of 3 millimeters.

Despite having the properties noted above, the polymer composition may nevertheless maintain a high degree of strength, which can provide enhanced flexibility and impact resistance. The polymer composition may, for example, exhibit a tensile stress at break (i.e., strength) of from about 40 MPa to about 300 MPa, in some embodiments from about 50 MPa to about 250 MPa, and in some embodiments, from about 70 to about 200 MPa; a tensile break strain (i.e., elongation) of about 0.5% or more, in some embodiments from about 1% to about 8%, and in some embodiments, from about 2% to about 5%; and/or a tensile modulus of from about 5,000 to about 30,000 MPa, in some embodiments from about 6,000 MPa to about 25,000 MPa, and in some embodiments, from about 9,000 MPa to about 22,000 MPa. The tensile properties may be determined in accordance with ISO 527:2019 at a temperature of 23° C. The composition may also exhibit a flexural strength of about 20 MPa or more, in some embodiments from about 50 to about 300 MPa, in some embodiments from about 70 to about 250 MPa, and in some embodiments, from about 80 to about 200 MPa and/or a flexural modulus of about 10,000 MPa or less, in some embodiments from about 5,000 MPa to about 30,000 MPa, in some embodiments from about 8,000 MPa to about 25,000 MPa, and in some embodiments, from about 9,000 MPa to about 20,000 MPa. The flexural properties may be determined in accordance with ISO 178:2019 at a temperature of 23° C. The polymer composition may also exhibit a high impact strength, which can provide enhanced flexibility for the resulting part. For example, the polymer composition may exhibit an unnotched Charpy impact strength of about 2 KJ/m² or more, in some embodiments from about 4 to about 20 KJ/m², and in some embodiments, from about 6 to about 18 KJ/m² and/or a notched Charpy impact strength of about 10 KJ/m² or more, in some embodiments from about 15 to about 50 kJ/m², and in some embodiments, from about 20 to about 40 KJ/m², as determined at a temperature of 23° C. in accordance with ISO 179-1:2010.

Various embodiments of the present invention will now be described in more detail.

### I. Polymer Composition

### A. Polymer Matrix

As indicated above, the polymer matrix contains at least one liquid crystalline polymer. For example, liquid crystalline polymers typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %). Liquid crystalline polymers are generally classified as “thermotropic” to the extent that they can possess a rod-like structure and exhibit a crystalline behavior in their molten state (e.g., thermotropic nematic state). Such polymers typically have a DTUL value of from about 200° C. to about 340° C., in some embodiments from about 210° C. to about 300° C., and in some embodiments, from about 220° C. to about 280° C., as determined in accordance with ISO 75-2:2013 at a load of 1.8 MPa. The polymers also have a relatively high melting temperature, such as from about 250° C. to about 440° C., in some embodiments from about 260° C. to about 400° C., and in some embodiments, from about 300° C. to about 380° C. The polymers may be formed from one or more types of repeating units as is known in the art. A liquid crystalline polymer may, for example, contain one or more aromatic ester repeating units generally represented by the following Formula (I):

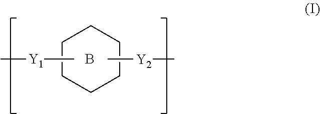

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 20 mol. % to about 80 mol. %, in some embodiments from about 25 mol. % to about 75 mol. %, and in some embodiments, from about 30 mol. % to 70 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl) ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 50 mol. %, in some embodiments from about 5 mol. % to about 40 mol. %, and in some embodiments, from about 10 mol. % to about 35 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl) ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 40 mol. %, in some embodiments from about 2 mol. % to about 35 mol. %, and in some embodiments, from about 5 mol. % to about 30 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although by no means required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 12 mol. % or more, in some embodiments about 15 mol. % or more, in some embodiments from about 15 mol. % to about 50 mol. %, and in some embodiments, from 16 mol. % to about 30 mol. % of the polymer. In one embodiment, for instance, the repeating units derived from NDA are within the ranges noted above. The liquid crystalline polymer may also contain various other monomers. For example, the polymer may contain repeating units derived from HBA in an amount of from about 20 mol. % to about 60 mol. %, and in some embodiments from about 25 mol. % to about 55 mol. %, and in some embodiments, from about 30 mol. % to about 50 mol. %. The polymer may also contain aromatic dicarboxylic acid(s) (e.g., IA and/or TA) in an amount of from about 1 mol. % to about 15 mol. % and/or aromatic diol(s) (e.g., BP and/or HQ) in an amount of from about 10 mol. % to about 35 mol. %. Of course, in other embodiments, the liquid crystalline polymer may be a “low naphthenic” polymer to the extent that it contains a relatively low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) may be about 10 mol. % or less, in some embodiments about 8 mol. % or less, and in some embodiments, from about 1 mol. % to about 6 mol. % of the polymer.

It is often desired that a substantial portion of the polymer matrix is formed from such high naphthenic polymers. For example, high naphthenic polymers such as described herein typically constitute 50 wt. % or more, in some embodiments about 65 wt. % or more, in some embodiments from about 70 wt. % to 100 wt. %, and in some embodiments, from about 80 wt. % to 100% of the polymer matrix (e.g., 100 wt. %). In some cases, blends of polymers may also be used. For example, low naphthenic liquid crystalline polymers may constitute from about 1 wt. % to about 50 wt. %, in some embodiments from about 2 wt. % to about 40 wt. %, and in some embodiments, from about 5 wt. % to about 30 wt. % of the total amount of liquid crystalline polymers in the composition, and high naphthenic liquid crystalline polymers may constitute from about 50 wt. % to about 99 wt. %, in some embodiments from about 60 wt. % to about 98 wt. %, and in some embodiments, from about 70 wt. % to about 95 wt. % of the total amount of liquid crystalline polymers in the composition.

### B. Optional Additives

In certain embodiments, the polymer composition may be formed entirely from the polymer matrix (i.e., 100 wt. %.). Of course, in other embodiments, one or more additives may be distributed throughout the polymer matrix to help provide the desired properties. When employed, such additive(s) typically constitute from about 0.1 to about 300 parts by weight, in some embodiments from about 0.5 to about 250 parts by weight, and in some embodiments, from about 1 to about 200 parts by weight per 100 parts by weight of the polymer matrix. The additive(s) may, for instance, constitute from about 0.1 wt. % to about 80 wt. %, in some embodiments from about 0.5 wt. % to about 70 wt. %, and in some embodiments, from about 1 wt. % to about 60 wt. % of the polymer composition.

In one particular embodiment, for example, the polymer composition may contain a thermally conductive filler distributed within the polymer matrix. To help achieve the desired balance between thermal conductivity, high flow, and good mechanical properties, the relative amount of the thermally conductive filler is typically controlled to be within a range of from about 10 to about 250 parts by weight, in some embodiments from about 40 to about 250 parts by weight, in some embodiments from about 60 to about 200 parts by weight, and in some embodiments, from about 80 to about 190 parts by weight per 100 parts by weight of the polymer matrix. The thermally conductive filler may, for instance, constitute from about 20 wt. % to about 70 wt. %, in some embodiments from about 28 wt. % to about 62 wt. %, in some embodiments from about 35 wt. % to about 65 wt. %, and in some embodiments, from about 40 wt. % to about 60 wt. % of the polymer composition.

If desired, the thermally conductive filler may include a material having a high degree of intrinsic thermal conductivity. For example, the polymer composition may be contain a material having an intrinsic thermal conductivity of 50 W/m−K or more, in some embodiments 100 W/m−K or more, and in some embodiments, 150 W/m−K or more. Examples of such high intrinsic thermally conductive materials may include, for instance, boron nitride, aluminum nitride, magnesium silicon nitride, graphite (e.g., expanded graphite), silicon carbide, carbon nanotubes, zinc oxide, magnesium oxide, beryllium oxide, zirconium oxide, yttrium oxide, aluminum powder, and copper powder. While such materials can be employed in certain embodiments, it has been discovered that a high degree of thermal conductivity can be achieved without use of conventional materials having a high degree of intrinsic thermal conductivity. For example, the polymer composition may be generally free of fillers having an intrinsic thermal conductivity. That is, such fillers may constitute about 10 wt. % or less, in some embodiments about 5 wt. % or less, and in some embodiments, from 0 wt. % to about 2 wt. % of the polymer composition (e.g., 0 wt. %).

In one particular embodiment, for instance, the thermally conductive filler may contain mineral particles. When employed, such mineral particles typically constitute from about 70 to about 250 parts by weight, in some embodiments from about 75 to about 200 parts by weight, and in some embodiments, from about 90 to about 190 parts by weight per 100 parts by weight of the polymer matrix. The mineral particles may, for instance, constitute from about 30 wt. % to about 70 wt. %, in some embodiments from about 35 wt. % to about 65 wt. %, and in some embodiments, from about 40 wt. % to about 60 wt. % of the polymer composition. The mineral particles may be formed from a natural and/or synthetic silicate mineral, such as talc, mica, halloysite, kaolinite, illite, montmorillonite, vermiculite, palygorskite, pyrophyllite, calcium silicate, aluminum silicate, wollastonite, etc. Talc is particularly suitable for use in the polymer composition. The shape of the particles may vary as desired, such as granular, flake-shaped, etc. The particles typically have a median particle diameter (D50) of from about 1 to about 25 micrometers, in some embodiments from about 2 to about 15 micrometers, and in some embodiments, from about 4 to about 10 micrometers, as determined by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

In addition to and/or in lieu of mineral particles, the thermally conductive filler may also contain mineral fibers (also known as “whiskers”). When employed, such mineral fibers typically constitute from about 10 to about 150 parts by weight, in some embodiments from about 15 to about 100 parts by weight, and in some embodiments, from about 20 to about 80 parts by weight per 100 parts by weight of the polymer matrix. The mineral fibers may, for instance, constitute from about 10 wt. % to about 50 wt. %, in some embodiments from about 15 wt. % to about 45 wt. %, and in some embodiments, from about 20 wt. % to about 40 wt. % of the polymer composition. Examples of such mineral fibers include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are inosilicates, such as wollastonite fibers available from Nyco Minerals under the trade designation NYGLOS® (e.g., NYGLOS® 4W or NYGLOS® 8). The mineral fibers may have a median diameter of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. In addition to possessing the size characteristics noted above, the mineral fibers may also have a relatively high aspect ratio (average length divided by median diameter) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

The polymer composition may also contain a variety of other optional components to help improve its overall properties. For example, the polymer composition may contain a metal hydroxide that is effectively capable of “losing” hydroxide ions during processing with the polymer to initiate chain scission of the polymer, which reduces molecular weight, and in turn, the melt viscosity of the polymer under shear. When employed, the metal hydroxide(s) may constitute from about 0.05 to about 10 parts, in some embodiments from about 0.1 to about 5 parts, and in some embodiments, from about 0.2 to about 3 parts by weight per 100 parts by weight of the polymer matrix. For example, the metal hydroxide(s) may constitute from about 0.01 wt. % to about 5 wt. %, in some embodiments from about 0.05 wt. % to about 4 wt. %, and in some embodiments, from about 0.1 wt. % to about 2 wt. % of the polymer composition.

One example of a suitable metal hydroxide has the general formula M(OH)ₛ, where s is the oxidation state (typically from 1 to 3) and M is a metal, such as a transitional metal, alkali metal, alkaline earth metal, or main group metal. Examples of suitable metal hydroxides may include copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. Also suitable are metal alkoxide compounds that are capable of forming a hydroxyl functional group in the presence of a solvent, such as water. Such compounds may have the general formula M(OR)ₛ, wherein s is the oxidation state (typically from 1 to 3), M is a metal, and R is alkyl. Examples of such metal alkoxides may include copper (II) ethoxide (Cu²⁺(CH₃CH₂O⁻)₂), potassium ethoxide (K⁺(CH₃CH₂O⁻)), sodium ethoxide (Na⁺(CH₃CH₂O⁻)), magnesium ethoxide (Mg²⁺(CH₃CH₂O⁻)₂), calcium ethoxide (Ca²⁺(CH₃CH₂O⁻)₂), etc.; aluminum ethoxide (Al³⁺(CH₃CH₂O⁻)₃), and so forth. In particular embodiments, the metal hydroxide may be in the form of metal hydroxide particles. For instance, the particles may contain at least one aluminum hydroxide having the general formula: Al(OH)ₐO_{b}, where 0≤a≤3 (e.g., 1) and b=(3−s)/2. In one particular embodiment, for example, the particles exhibit a boehmite crystal phase and the aluminum hydroxide has the formula AlO(OH) (“aluminum oxide hydroxide”). The metal hydroxide particles may be needle-shaped, ellipsoidal-shaped, platelet-shaped, spherical-shaped, etc. Regardless, the particles typically have a median particle diameter (D50) of from about 50 to about 800 nanometers, in some embodiments from about 150 to about 700 nanometers, and in some embodiments, from about 250 to about 500 nanometers, as determined by non-invasive back scatter (NIBS) techniques. If desired, the particles may also have a high specific surface area, such as from about 2 square meters per gram (m²/g) to about 100 m²/g, in some embodiments from about 5 m²/g to about 50 m²/g, and in some embodiments, from about 10 m²/g to about 30 m²/g. Surface area may be determined by the physical gas adsorption (BET) method (nitrogen as the adsorption gas) in accordance with ISO 9277:2010. The moisture content may also be relatively low, such as about 5% or less, in some embodiments about 3% or less, and in some embodiments, from about 0.1 to about 1% as determined in accordance with ISO 787-2:1981.

Still other components that can be included in the composition may include, for instance, reinforcing fibers (e.g., glass fibers), pigments (e.g., black pigments), antioxidants, stabilizers, crosslinking agents, lubricants, impact modifiers, flow promoters, and other materials added to enhance properties and processability.

### II. Melt Processing

The manner in which the liquid crystalline polymer and various other optional additives (e.g., thermally conductive filler, pigment, lubricant, etc.) are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 150° C. to about 450° C., and in some embodiments, from about 250° C. to about 400° C. Likewise, the apparent shear rate during melt processing may range from about 100 seconds⁻¹to about 10,000 seconds⁻¹, and in some embodiments, from about 500 seconds⁻¹to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. Temperature Sensor

Although any suitable shaped part can be formed, the polymer composition of the present invention is particularly useful in forming temperature sensors. Generally speaking, the temperature sensor includes a housing that receives at least one temperature measuring element (e.g., thermistor, thermocouples, etc.). The housing may be a monolithic structure containing the polymer composition, or it may contain two or more separate portions, one or more of which contain the polymer composition. In one embodiment, for example, the housing may include a sensor housing and a a connector housing. In such embodiments, the polymer composition may be used to form any portion of the sensor housing and/or connector housing. The sensor housing may contain an opening within which a temperature sensing element may be received. The connector housing may likewise contain an opening having a first end and a second end, and a lead of the temperature sensing element may be received through a first end of the opening. Electric wires may also be received within a second end of the opening for electrically connecting to the lead. The electric wires typically extend beyond the periphery of the connector housing to electrically connect to another electronic component, e.g., in a battery module. If desired, the connector housing may be inserted into the sensor housing to enhance protection of the temperature measuring element and/or electric wires.

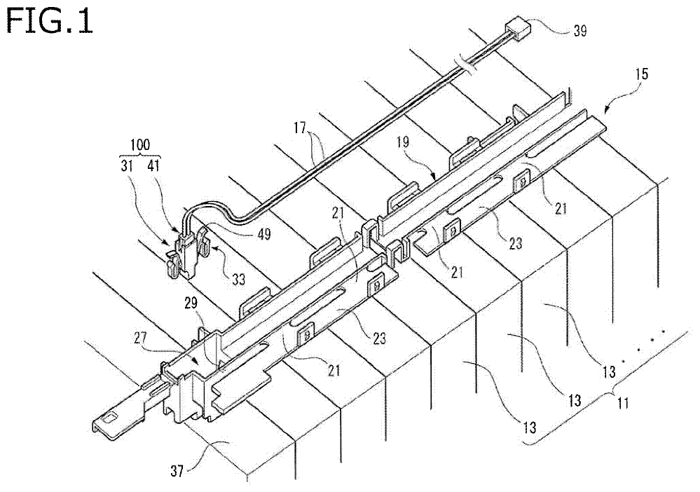

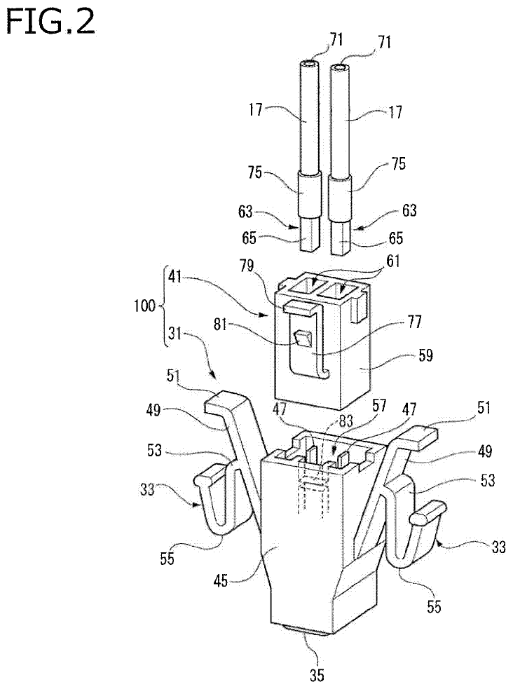

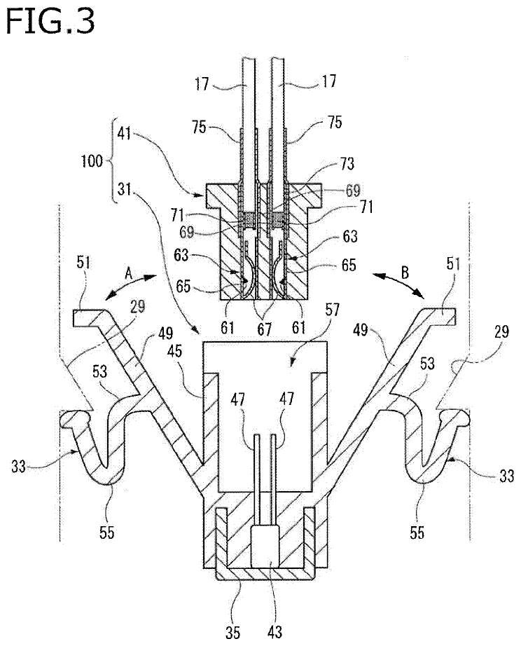

Referring to FIGS. 2-3, for example, one particular embodiment of a temperature sensor 100 containing multiple housing structures is shown in more detail. As shown, the temperature sensor 100 generally includes a sensor body 31 and a connector body 41. The sensor body 31 includes a sensor housing 45 and a case that covers a periphery of a thermistor 43 serving as a temperature measuring element. The sensor housing 45 also includes the temperature measuring portion 35. A tip end of the temperature measuring portion 35 has a flat surface that may contact a temperature measurement target surface 37 of the unit cell 13 (FIG. 1). In addition, a lead 47 connected to the thermistor 43 provided in the sensor housing is drawn out from a rear end of the sensor housing 45, and the lead 47 is connected to a temperature measuring device or a temperature measuring circuit board of the ECU via the connector body 41 and the electric wire 17.

Although optional, the sensor housing 45 of FIGS. 2-3 may also include sensor-side locking arms 33 that extend on both sides of a main wall of the sensor housing 45. A free end being a tip end of the sensor-side locking arms 33 may be locked to a locking portion 29 provided at a fixed position with respect to the surface of a battery unit cell 13 (FIG. 1), and thus the sensor-side locking arms 33 may be positioned and fixed to the unit cell 13. In the embodiment, the locking portion 29 protrudes to press the free end of the sensor-side locking arms 33 toward the unit cell 13 (FIG. 1), and may be formed integrally with a busbar 15 (FIG. 1) on a battery module fixed to the surface side of the unit cell 13 (FIG. 1). The sensor body 31 may be attached to the busbar 15 (FIG. 1) in such a manner that a free end of the sensor-side locking arms 33 may be subjected to a pressing load toward the surface of the unit cell 13 by the locking portion 29. The close contact state between the temperature measuring portion 35 and the temperature measurement target surface 37 of a battery unit cell 13 (FIG. 1) may be secured by an elastic restoring force of the sensor-side locking arms 33 in the sensor body 31. The sensor-side locking arms 33 may be provided on a flexible member 49 extending in an elastically displaceable manner in the sensor housing 45. The flexible members 49 are arms that extend rearward from the outer periphery of the sensor housing 45, and are provided on both sides of the sensor housing 45. In addition, upon receiving an external force, the flexible member 49 may be elastically displaceable in directions of arrows A and B in FIG. 3. The free end side of the flexible member 49 may serve as a grip portion 51 to be gripped when the sensor body 31 is attached to the sensor attachment hole 27 of the busbar 15 (FIG. 1).

In the illustrated embodiment, the sensor-side locking arms 33 on both sides extend from the middle of the flexible member 49. Each of the sensor-side locking arms 33 is provided with a first bent portion 53 serving as a branch portion from the flexible member 49 and a second bent portion 55 adjacent to the first bent portion 53, the first bent portion and the second bent portion being bent portions that is flexibly deformed according to a load acting on the free end. The first bent portion 53 has a smoothly curved shape that protrudes upward, and the second bent portion 55 has a smoothly curved shape that protrudes downward. At an intermediate position between the first bent portion 53 and the second bent portion 55, an inflection point to be shifted from the first bent portion 53 to the second bent portion 55 is set. That is, the first bent portion 53 and the second bent portion 55 form a bent shape having a smooth waveform similar to a sin curve. In addition, the first bent portion 53 has a smoothly curved shape in which the flexible member 49 is a circumscribing tangent line.

The sensor housing 45 may also be formed with a connector fitting opening 57 through which the lead 47 extends. A protruding tip end of the lead 47 is disposed on a back side of the connector fitting opening 57. That is, the lead 47 can be used as a male terminal. A connector housing 59 of the connector body 41 may be fitted to the connector fitting opening 57. A pair of terminal accommodating bores 61 may be formed in the connector housing 59. A terminal 63 may be attached to each of the bores 61. For example, the terminal 63 may be retained and fixed by a flexible locking claw (not illustrated) formed integrally with the connector housing 59 protruding inward of the terminal accommodating chamber 61. The terminal 63 may include a box-like electric contact portion 65 on a front end side in a coupling direction. The lead 47 may be inserted into the electric contact portion 65. That is, the terminal 63 may be a female terminal. An elastic contact piece 67 may be formed inside the electric contact portion 65. The elastic contact piece 67 makes elastic contact with the lead 47 inserted into the electric contact portion 65, and electrically connects the terminal 63 to the lead 47. A conductor crimping portion 69 may be formed at a rear side of the electric contact portion 65. The conductor crimping portion 69 may include a pair of caulking pieces, and the pair of caulking pieces may be caulked to a conductor 71 of the electric wire 17. An electric wire crimping portion 73 may be formed at a rear side of the conductor crimping portion 69. The electric wire crimping portion 73 may include a pair of electric wire caulking pieces. The electric wire crimping portion 73 caulks the pair of electric wire caulking piece from an outer side of the covering of the electric wire 17, thereby connecting the terminal 63 to the electric wire 17 with high strength. An insulating tube 75 may be further covered on the conductor crimping portion 69, the electric wire crimping portion 73, and a part of the end of the electric wire 17.

As illustrated in FIG. 2, a connector-side locking arm 77, which is a connector-side locking member, may be formed on the connector housing 59 of the connector body 41. A base end of the connector-side locking arm 77 may be connected to the connector housing 59 and a tip end thereof protrudes toward the side opposite to the insertion direction. A knob portion 79 may be formed at the protruding tip end of the connector-side locking arm 77. The connector-side locking arm 77 may be elastically deformed by being gripped in a direction in which the knob portion 79 approaches the connector housing 59. A lock claw 81 protruding outward on the opposite side of the connector housing 59 is projected substantially in the middle of the connector-side locking arm 77 in the extending direction. The lock claw 81 is locked to a locked portion 83 formed on an inner surface of the connector fitting opening 57 in the sensor housing 45. When the connector housing 59 is inserted into the connector fitting opening 57 of the sensor housing 45, the connector body 41 is elastically deformed in a direction in which the connector-side locking arm 77 approaches the connector housing 59 by a reaction force from the connector fitting opening 57. The lead 47 of the thermistor 43 is also inserted into the electric contact portion 65 of the terminal 63 and sandwiched by the elastic contact piece 67. At the same time, the lock claw 81 of the connector-side locking arm 77 is locked to the locked portion 83 of the sensor housing 45. As a result, the separation of the connector body 41 from the sensor body 31 is regulated. That is, the sensor body 31 and the connector body 41 are locked to each other in a coupled state.

Generally speaking, any portion of the sensor body 31 and/or

connector body 41 of the temperature sensor 100 shown in FIGS. 2-3 may contain the polymer composition described herein. For example, the polymer composition may be used to form the main structure of the sensor housing 45 itself, the locking arms 33, flexible members 49, the connector housing 59, connector-side locking arm 77, etc.

### IV. Battery Module

Although not required, the temperature sensor of the present invention is particularly well suited for use in a battery module. For example, the temperature sensor may be attached to a portion of the battery module (e.g., busbar, battery cell unit, etc.) to monitor temperature during use of the module. Referring to FIG. 1, for example, one embodiment of a battery module 11 is shown that may contain the temperature sensor 100 described above and shown in FIGS. 2-3. As shown, the battery module 11 may be formed by stacking a plurality of unit cells 13 in series. To prevent over-charge and over-discharge of the battery module 11, the temperature sensor 100 may be attached to the battery module 11 to monitor temperature. A busbar 15 may be fixed to the battery module 11 and may include a busbar accommodating portion (not illustrated) for accommodating a busbar and an electric wire arranging portion 19 for arranging a detection wire for a voltage detecting sensor or an electric wire 17 for the temperature sensor. The electric wire arranging portion 19 may be closed by a lid 23 formed integrally with the busbar 15 with a hinge 21. These electric wires 17 are accommodated and fixed in the electric wire arranging portion 19.

A sensor attachment hole 27 may be formed in the electric wire arranging portion 19 of the busbar 15. A pair of locking portions 29 may be formed in the sensor attachment hole 27 (see FIG. 3). The locking portion 29 may be locked to the sensor-side locking arm 33 of the temperature sensor 100. At a position where the busbar 15 is attached to the battery module 11 as shown in FIG. 1, the sensor attachment hole 27 holds the temperature sensor 100 at a position where a temperature measuring portion 35 of the temperature sensor 100 comes in contact with a temperature measurement target surface 37 of the unit cell 13. The temperature sensor 100 detects a temperature of the unit cell 13 by coming in contact with the temperature measurement target surface 37. The temperature sensor 100 is connected to the electric wire 17, and is connected to an ECU (electronic control unit) via a temperature detecting connector 39 connected to an end of the electric wire 17. The sensor attachment hole 27 can be provided corresponding to arbitrary unit cells 13 in the battery module 11. That is, the sensor attachment hole 27 may be provided at one location or a plurality of locations corresponding to arbitrary unit cells 13.

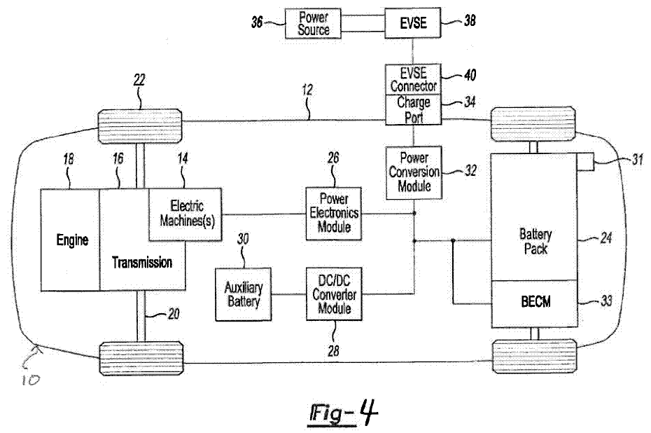

The temperature sensor and battery module may be employed in a wide variety of product applications, but is particularly beneficial for use in an electric motor of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 4, for instance, one embodiment of an electric vehicle 12 that includes a powertrain 10 is shown. The powertrain 10 contains one or more electric machines 14 connected to a transmission 16, which in turn is mechanically connected to a drive shaft 12 and drive wheels 22. Although by no means required, the transmission 16 in this particular embodiment is also connected to an engine 18, though the description herein is equally applicable to a pure electric vehicle. The electric machines 14 may be an electric motor containing a stator/rotor system to provide propulsion and deceleration capability. The powertrain 110 also includes a propulsion source, such as a battery module 24, which stores and provides energy for use by the electric machines 14. The battery module 24 typically provides a high voltage current output (e.g., DC current at a voltage of from about 400 volts to about 800 volts) from one or more battery cell arrays that may include one or more battery cells.

The powertrain 10 may also contain at least one power electronics module 26 that is connected to the battery module 24 (also commonly referred to as a battery pack) and that may contain a power converter (e.g., converter, etc., as well as combinations thereof). The power electronics module 26 is typically electrically connected to the electric machines 14 and provides the ability to bi-directionally transfer electrical energy between the battery module 24 and the electric machines 14. For example, the battery module 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the battery module 24. The battery module 24 may also provide energy for other vehicle electrical systems. For example, the powertrain may employ a DC/DC converter module 28 that converts the high voltage DC output from the battery module 24 to a low voltage DC supply that is compatible with other vehicle loads, such as compressors and electric heaters. In a typical vehicle, the low-voltage systems are electrically connected to an auxiliary battery (e.g., 12V battery). A battery energy control module (BECM) 33 may also be present that is in communication with the battery module 24 that acts as a controller for the battery module 24 and may include an electronic monitoring system that manages temperature and charge state of each of the battery cells. The battery module 24 may also have a temperature sensor 31, such as discussed above and formed in accordance with the present invention. The temperature sensor 31 may be in communication with the BECM 33 to provide temperature data regarding the battery module 24. The temperature sensor 31 may also be located on or near the battery cells within the traction battery 24. It is also contemplated that more than one temperature sensor 31 may be used to monitor temperature of the battery cells.

The battery module 24 may be recharged by an external power source 36, such as an electrical outlet. The external power source 36 may be electrically connected to electric vehicle supply equipment (EVSE) that regulates and manages the transfer of electrical energy between the power source 36 and the vehicle 12. The EVSE 38 may have a charge connector 40 for plugging into a charge port 34 of the vehicle 12. The charge port 34 may be any type of port configured to transfer power from the EVSE 38 to the vehicle 12 and may be electrically connected to a charger or on-board power conversion module 32. The power conversion module 32 may condition the power supplied from the EVSE 38 to provide the proper voltage and current levels to the battery module 24. The power conversion module 32 may interface with the EVSE 38 to coordinate the delivery of power to the vehicle 12.

### Test Methods

Thermal Conductivity: As is known in the art, the thermal diffusivity of a sample in various directions (in-plane, cross-plane, through-plane) may be initially determined based on the laser flash method in accordance with ASTM E1461-13(2022). The thermal conductivity (in-plane, cross-plane, and through-plane) may then be calculated according to the following formula: Thermal Conductivity (W/m*K) =Cp*ρ*α, where Cρ is the specific heat capacity (J/kgK) of the sample, ρ is the intrinsic density (kg/m³) of the sample as determined in accordance with ISO 11831-1:2019 (Method A), and α is the measured thermal diffusivity (m²/s).

Melt Viscosity: The melt viscosity (Pa−s) may be determined in accordance with ISO 11443:2021 at a shear rate of 1,000 s−¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm. The melt viscosity is typically determined at a temperature 15° C. above the melting temperature of the polymer and/or composition, such as about 350° C.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-3:2018. Under the DSC procedure, samples were heated and cooled at 20° C. per minute as stated in ISO Standard 10350 using DSC measurements conducted on a TA Q2000 Instrument.

Tensile Modulus, Tensile Stress at Break, and Tensile strain at Break: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min for tensile strength and tensile strain at break, and 1 mm/min for tensile modulus.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

### EXAMPLES 1-2

The following two (2) commercially available samples were compounded and injection molded for use in a temperature sensor.

| | Ex. 1 | Ex. 1 | Ex. 2 | Ex. 2 |
|---|---|---|---|---|
| | (wt. %) | (parts) | (wt. %) | (parts) |
| LCP 1 | — | 100 | 65.45 | 100 |
| LCP 2 | 46.3 | | — | |
| Nylgos ® 8 | — | — | 30.0 | 46 |
| Boron Nitride | 53.7 | 116 | — | — |
| Lubricant | — | — | 0.3 | 0.5 |
| Carbon Black | — | — | 3.75 | 6 |

LCP 1 is formed from 73% HBA and 27% HNA. LCP 2 is believed to be formed from 50% HBA, 25% BP, and 25% TA. The samples were tested for mechanical properties, thermal properties, and thermal conductivity as described herein. The results are set forth below.

| | Ex. 1 | Ex. 2 |
|---|---|---|
| Tensile Modulus (MPa) | 9,887 | 14,000 |
| Tensile Strength (MPa) | 50 | 143 |
| Tensile Elongation (%) | 0.86 | 2.7 |
| Flexural Modulus (MPa) | 13,500 | 13,000 |
| Flexural Strength (MPa) | 79 | 160 |
| Charpy Impact Strength | 7.0 | 29 |
| (Un-Notched) (kJ/m²) | | |
| Charpy Impact Strength | 3.6 | 10 |
| (Notched) (kJ/m²) | | |
| DTUL (° C.) | 228 | 240 |
| Tm (° C.) | 345-350 | 335 |
| Melt Viscosity (Pa-s) | 254 (380° C.) | 42 |
| at 1,000 s⁻¹ | | |
| TC, In-Plane (W/mK) | 9.4 | 2.5 |
| TC, Cross Plane (W/mK) | 9.0 | 1.0 |
| TC, Through Plane (W/mK) | 1.9 | 0.6 |
| Dielectric Strength (kV/mm) | — | 30 |
| CTI (V) | — | 175 |

### EXAMPLE 3

The following sample was compounded and injection molded for use in a temperature sensor.

| | Ex. 3 | Ex. 3 |
|---|---|---|
| | (wt. %) | (parts) |
| LCP 3 | 37.3 | 100 |
| LCP 1 | 5.6 | |
| Talc | 54.0 | 126 |
| Hydrated Alumina | 0.4 | 0.9 |
| Lubricant | 0.3 | 0.7 |
| Carbon Black | 2.4 | 6 |

LCP 3 is formed from 43% HBA, 20% NDA, 9% TA, and 28% HQ. The samples were tested for mechanical properties, thermal properties, and thermal conductivity as described herein. The results are set forth below.

| | Ex. 3 |
|---|---|
| Tensile Modulus (MPa) | 10,000 |
| Tensile Strength (MPa) | 82 |
| Tensile Elongation (%) | 2.1 |
| Flexural Modulus (MPa) | 10,000 |
| Flexural Strength (MPa) | 109 |
| Charpy Impact Strength | 13 |
| (Un-Notched) (kJ/m²) | |
| Charpy Impact Strength | — |
| (Notched) (kJ/m²) | |
| DTUL (° C.) | 261 |
| Melt Viscosity (MPa-s) | 43.6 |
| at 1,000 s⁻¹ | |
| Tm (° C.) | 315 |
| TC, In-Plane (W/mK) | 4.8 |
| TC, Cross Plane (W/mK) | 3.4 |
| TC, Through Plane (W/mK) | 0.8 |
| Dielectric Strength (kV/mm) | 41 |
| CTI (V) | 250 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A temperature sensor comprising a housing that receives a temperature measuring element, wherein the housing includes a polymer composition that comprises a polymer matrix that includes a thermotropic liquid crystalline polymer, further wherein the polymer composition exhibits a melt viscosity of about 300 Pa−s or less as determined in accordance with ISO 11443:2021 at a shear rate of 1,000 s⁻¹ and temperature of about 15° C. above the melting temperature of the composition, and a deflection temperature under load of about 170° C. or more as determined in accordance with ISO 75:2013 at a load of 1.8 MPa.

2. The temperature sensor of claim 1, wherein the polymer composition exhibits a melting temperature of about 250° C. to about 440° C.

3. The temperature sensor of claim 1, wherein the thermotropic liquid crystalline polymer contains repeating units derived from one or more aromatic dicarboxylic acids, one or more aromatic hydroxycarboxylic acids, or a combination thereof.

4. The temperature sensor of claim 3, wherein the aromatic hydroxycarboxylic acids include 4-hydroxybenzoic acid, 6-hydroxy-2-naphthoic acid, or a combination thereof.

5. The temperature sensor of claim 4, wherein the aromatic dicarboxylic acids include terephthalic acid, isophthalic acid, 2,6-naphthalenedicarboxylic acid, or a combination thereof.

6. The temperature sensor of claim 3, wherein the liquid crystalline polymer further contains repeating units derived from one or more aromatic diols.

7. The temperature sensor of claim 6, wherein the aromatic diols include hydroquinone, 4,4′-biphenol, or a combination thereof.

8. The temperature sensor of claim 1, wherein the thermotropic liquid crystalline polymer is wholly aromatic.

9. The temperature sensor of claim 1, wherein the thermotropic liquid crystalline polymer includes repeating units derived from naphthenic hydroxycarboxylic and/or dicarboxylic acids in an amount of about 10 mol. % or more.

10. The temperature sensor of claim 1, wherein the polymer composition exhibits an in-plane thermal conductivity of about 2 W/m−K or more as determined in accordance with ASTM E1461-13(2022).

11. The temperature sensor of claim 1, wherein the polymer composition exhibits a cross-plane thermal conductivity of about 0.8 W/m−K or more as determined in accordance with ASTM E 1461-13(2022).

12. The temperature sensor of claim 1, wherein the polymer composition exhibits an in-plane thermal conductivity of from about 4 to about 8 W/m−K, as determined in accordance with ASTM E 1461-13(2022).

13. The temperature sensor of claim 1, wherein the polymer composition exhibits a dielectric strength of about 10 kilovolts per millimeter or more as determined in accordance with IEC 60234-1:2013.

14. The temperature sensor of claim 1, wherein the polymer composition further comprises a thermally conductive filler.

15. The temperature sensor of claim 14, wherein the thermally conductive filler includes mineral particles.

16. The temperature sensor of claim 15, wherein the mineral particles include talc.

17. The temperature sensor of claim 15, wherein the mineral particles constitute from about 70 to about 250 parts by weight per 100 parts by weight of the polymer matrix.

18. The temperature sensor of claim 15, wherein the mineral particles have a median diameter of from about 1 to about 25 micrometers, specific surface area of from about 1to about 50 m²/g as determined in accordance with DIN 66131:1993, and/or moisture content of about 5% or less as determined in accordance with ISO 787-2:1981 at a temperature of 105° C.

19. The temperature sensor of claim 14, wherein the thermally conductive filler includes mineral fibers.

20. The temperature sensor of claim 19, wherein the mineral fibers include wollastonite.

21. The temperature sensor of claim 20, wherein the mineral fibers constitute from about 10 to about 150 parts by weight per 100 parts by weight of the polymer matrix.

22. The temperature sensor of claim 1, wherein the polymer composition is free of fillers having an intrinsic thermal conductivity of 100 W/m−K or more.

23. The temperature sensor of claim 1, wherein the polymer composition exhibits a comparative tracking index of about 170 volts or more as determined in accordance with IEC 60112:2003 at a thickness of 3 millimeters.

24. The temperature sensor of claim 1, wherein the temperature measuring element includes a thermistor.

25. The temperature sensor of claim 1, wherein the housing includes a sensor housing that defines an opening within which the temperature measuring element is positioned.

26. The temperature sensor of claim 25, wherein the sensor housing includes the polymer composition.

27. The temperature sensor of claim 25, wherein the housing further comprises a connector housing that is inserted into the sensor housing, wherein the connector housing contains an opening through which a lead of the temperature measuring element is capable of being received.

28. The temperature sensor of claim 27, wherein the connector housing includes the polymer composition.

29. A battery module containing a battery cell unit and the temperature sensor of any of claim 1, wherein the temperature sensor is positioned to contact a temperature measurement target surface of the unit cell.

30. An electric vehicle comprising a powertrain and a transmission that is connected to a battery module.
